(19) United States
(12) Patent Application Publication
(10) Pub. No.: US 2011/0215740 A1
(43) Pub. Date: Sep. 8, 2011

(54) SYSTEMS AND DEVICES INCORPORATING MAGNETIC SWITCHES

(76) Inventor: Jeff Ellis, Estacada, OR (US)

(21) Appl. No.: 12/715,867

(22) Filed: Mar. 2, 2010

(51) Int. Cl. H05B 37/02

(52) U.S. Cl. 315/362; 335/207

(57) ABSTRACT

Portable lighting systems and devices including a first power source that is magnetically attractable and that has a first terminal with a first electrical polarity and a second terminal with a second electrical polarity, a second power source having a third terminal with the first electrical polarity and a fourth terminal with the second electrical polarity, a light source electrically connected to the first terminal and to the fourth terminal, and a biasing mechanism biasing the first power source toward an activated position where the second terminal is in contact with the fourth terminal to define an electrical circuit, wherein in the presence of a magnetic field the first power source moves into a deactivated position where the second terminal is spaced from the fourth terminal to open the electrical circuit.

### BACKGROUND

The present disclosure relates generally to systems and devices incorporating magnetic switches. In particular, the present disclosure describes portable lighting systems and devices incorporating novel magnetic switching mechanisms for selectively turning on and off a light source. The portable lighting systems and devices are for illuminating a given space or subject without being tethered to a fixed power source and are just one example of a system or device that may incorporate the magnetic switching mechanisms described herein.

Portable lighting devices are used in a variety activities, including camping, hiking, boating, and traveling. Such devices find utility in a host of everyday situations, such as lighting up a room in the event of a power failure, illuminating one's car on a dark night, and providing light in spaces shielded from other sources of light, such as underneath furniture. In some applications, portable lighting devices may be selectively secured to an item, such as clothing, a wall, or a vehicle.

Thus, there exists a need for portable lighting systems and devices that improve upon and advances the design of known portable lighting systems and devices. Examples of new and useful portable lighting systems and devices relevant to the needs existing in the field are discussed below.

Disclosure addressing one or more of the identified existing needs is provided in the detailed description below. Examples of references relevant to portable lighting systems and devices include U.S. Patent References: 2006/0250790; 2009/0212116; 2009/0067165; U.S. Pat. Nos. 2,743,353; 3,924,117; 4,027,278; 4,638,409; 4,897,572; 5,178,453; 5,265,275; 6,511,214; 6,749,317; 7,059,079; 7,066,614 7,222,982. The complete disclosures of the above patents and patent applications are herein incorporated by reference for all purposes.

### SUMMARY

The present disclosure is directed to portable lighting systems and devices including a first power source that is magnetically attractable and that has a first terminal with a first electrical polarity and a second terminal with a second electrical polarity, a second power source having a third terminal with the first electrical polarity and a fourth terminal with the second electrical polarity, a light source electrically connected to the first terminal and to the fourth terminal, and a biasing mechanism biasing the first power source toward an activated position where the second terminal is in contact with the fourth terminal to define an electrical circuit, wherein in the presence of a magnetic field the first power source moves into a deactivated position where the second terminal is spaced from the fourth terminal to open the electrical circuit.

### BRIEF DESCRIPTION OF THE DRAWINGS

FIG. 1 is a perspective view of a first example of a portable lighting system including a portable lighting device and a primary magnet.

FIG. 2 is a bottom plan view of a section of the portable lighting device shown in FIG. 1 about plane 2-2 depicting two power sources in an activated position.

FIG. 3 is a side elevation view of the portable lighting system of FIG. 1 being held in position through an object by a clamp magnet.

FIG. 4 is a side elevation view of the portable lighting system of FIG. 1 with the portable lighting device held in a transverse orientation relative to the primary magnet by a magnetic field.

FIG. 5 is a side elevation view of the portable lighting system of FIG. 1 including a style held in a transverse orientation relative to the primary magnet by a magnetic field to define a sundial.

FIG. 6 is a bottom elevation view of a second example of a portable lighting device including an auxiliary magnet biasing two power sources into an activated position.

FIG. 7 is a top elevation view of a third example of a portable lighting device including planar electrical contacts.

FIG. 8 is a side elevation view of the portable lighting system of FIG. 1 including a system housing.

### DETAILED DESCRIPTION

The disclosed portable lighting systems and devices will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, a variety of examples of portable lighting systems and devices are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

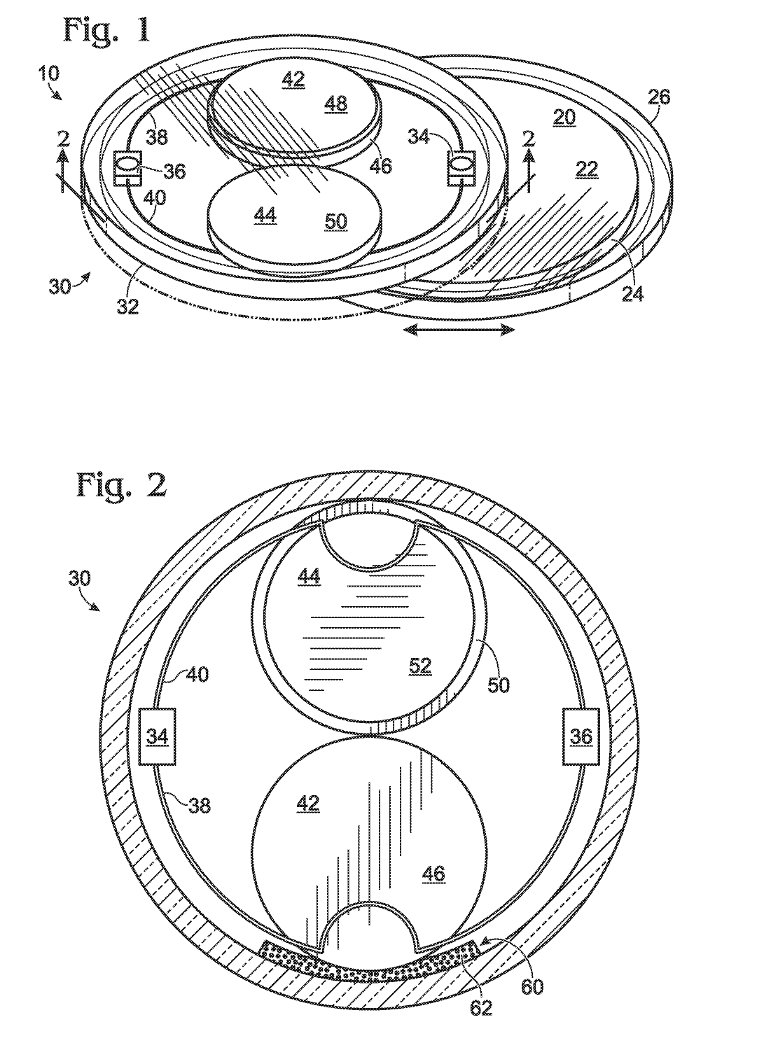

With reference to FIG. 1, a portable lighting system 10 includes a primary magnet 20 and a portable lighting device 30. Primary magnet 20 produces a magnetic field and portable lighting device 30 includes components that are attracted to the magnetic field. Thus, lighting device 30 and primary magnet 20 can secured together by magnetic attraction when at rest. Alternatively, a user may overcome the force of magnetic attraction and separate lighting device 30 from primary magnet 20. Thus, portable lighting device 30 can stand alone and be used independently of primary magnet 20.

FIG. 1 depicts two of many positions that portable lighting device 30 and primary magnet 20 may adopt relative to each other. In dashed lines, portable lighting device 30 is shown in a proximate position proximate to primary magnet 20. In the example shown in FIG. 1, lighting device 30 overlies primary magnet 20 in the proximate position. In some examples, lighting device 30 partially overlies primary magnet 20 or is adjacent to primary magnet 20 in the proximate position.

With further reference to FIG. 1, portable lighting device 30 is shown in solid lines in a distal position. In the specific example shown in FIG. 1, lighting device 30 is partially offset from primary magnet 20 in the distal position. In other examples, lighting device 30 is spaced from primary magnet 20 in the distal position.

As will be explained in more detail below, portable lighting device 30 is configured to selectively illuminate based on its position relative to primary magnet 20. The present example of portable lighting device 30 shown in FIG. 1 is configured to illuminate when in the distal position. In other examples, the lighting device is configured to illuminate when in the proximate position.

The magnetic switch functionality provided by the unique combination and interaction of magnets and power supplies discussed herein may be described as an Ellis Switch in view of the present applicant and inventor. Such switches find application in a wide range of devices beyond lighting devices. Indeed, the inventor contemplates uses of Ellis Switches in electronic devices, especially portable electronic devices such as radios, cell phones, personal data assistants, computers, and global positioning systems.

As can be seen in FIG. 1, primary magnet 20 includes a first major face 22 and a second major face opposite first major face 22. In the example shown in FIG. 1, primary magnet 20 has a circular periphery 24. In this particular example of portable lighting system 10, primary magnet 20 is contained in an optional magnet housing 26.

Magnet housing 26 shown in FIG. 1 is a clear case having a slightly larger size than primary magnet 20 and is generally the same shape as primary magnet 20. The inventor has found a standard silver dollar coin case to be a suitable magnet case.

The magnet housing (and the lighting housing as will shortly be explained) can be modified in a variety of ways for different functionality or applications. For instance, in some examples the magnet case is opaque, such as with a mirrored finish, or partially opaque. In still other examples the magnet case has a size significantly larger than the primary magnet and/or a shape dissimilar to the shape of the primary magnet. In yet further examples, the magnet housing is flexible and made from rubber or is coated with rubber.

Primary magnet 20 produces a magnetic field that acts on magnetically attractable materials, including a variety of metals. Primary magnet 20 may include a wide variety of soft or hard (i.e., semi-permanent or permanent,) magnetic or ferromagnetic materials, such as materials including iron, nickel, cobalt, lodestone, rare earth metals, and alloys thereof. The inventor has found grade N42 rare earth neodymium magnets to be a suitable primary magnet. In some examples, the primary magnet is an electromagnet.

In the example shown in FIG. 1, the magnetic field is axially oriented with regard to first major face 22, which defines a magnetic pole with a first polarity, for example, “north,” and the second major face, which defines a second magnetic pole with a second polarity, for example, “south.” In other examples, the polarity of each face is reversed. In still other examples, the primary magnet defines an axially and segmented magnetic field, a magnetic field oriented transverse to the axis of the primary magnet, or a magnetic field with multiple poles on the first or second major face.

With particular reference to FIG. 2 and with further reference to FIGS. 1 and 3-5, a first example of a portable lighting device 30 will be described. As can be seen in FIG. 2, portable lighting device 30 includes a light housing 32, which encloses a first light source 34, a second light source 36, a first electrical contact 38, a second electrical contact 40, a first power source 42, a second power source 44, and a biasing mechanism 60.

Light housing 32 shown in FIGS. 1 and 2 is substantially similar to magnet housing 26 and the discussion above directed to magnet housing 26 applies fully with regard to light housing 32. However, the light housing may be modified to better accommodate the components of lighting device 30. For example, an outer lip of the light housing may be bored out to seat an edge of first power source 42 and/or second power source 44. One side of the light housing may be bored out wider than the other side to provide increased tolerance or to enable the power source to move from side to side.

In other examples, the light housing is wholly or partially different than magnet housing 26. For example, the light housing may include extra compartments, such as a battery compartment and/or light compartment, which may have a mirrored finish. In some examples, the portable lighting device does not include a light housing.

The light housing and/or the magnet housing are substantially watertight in some examples. In such examples, the portable lighting system can be configured to float in water (or other fluid) by enclosing a sufficient volume of air (or other gas) in the magnet case and/or the light case for a given weight of the portable lighting system to render the portable lighting system buoyant in water. Sometimes compressed air is used. By modifying the enclosed air-to-system weight ratio, the level at which the system floats relative to the surface can be adjusted.

Additionally or alternatively, floating capability may be achieved by including foam or other buoyant material inside the light housing and/or the magnet housing. In some examples, floating capabilities are achieved by using rubber or other buoyant materials to form light housing and/or magnet housing.

In some applications, the light housing and/or the magnet housing are configured to house rescue related information, such as pictures, medical information, or contact information. Of course, any relevant type of information capable of fitting inside the light and/or magnet housing may be housed inside the housings. As the portable lighting systems and devices described herein may be used in camping, hiking, boating, and other outdoor recreation activities, it may be beneficial to house rescue information in the portable lighting system. For example, a picture of the user, medical information, or contact information would be beneficial in the event the user is in need of emergency and/or medical rescue.

For example, the user may become unconscious while wearing the portable lighting system. A passerby or medical rescue team seeing the light illuminating from the portable lighting system would then be able to find the unconscious user. Upon finding the unconscious user, the rescue information housed in the light and/or magnet housing would enable the passerby or medical rescue team to more effectively help the user.

A related scenario where rescue information being housed in the light and/or magnet housing would be beneficial is the scenario where the user becomes lost in the woods. With such information stored in the portable lighting system, the user may leave one or more portable lighting systems behind to mark the trail he is following. When someone sees light illuminating from the portable lighting system and comes across the system, the rescue information contained in the housing would help with the search and rescue effort.

In FIGS. 1-5, first and second light sources 34 and 36 are conventional light emitting diodes (“LEDs”) having positive and negative leads (not pictured). The light sources may be any light source with a size and power requirements appropriate for the other components of the portable lighting device. Light sources emitting light in a variety of colors may be selected for different applications, such as decoration, night illumination, or task lighting.

With particular reference to FIGS. 1 and 2, it can be seen that first and second electrical contacts 38 and 40 are conductive wires in this particular example. In the example show in FIGS. 1-5, electrical contacts 38 and 40 have a round cross section. In other examples, such as to provide more space within the light housing for other components, one or more of the electrical contacts have a cross section with a square, rectangular, or other regular or irregular polygonal shape.

In the example shown in FIGS. 1-5, power sources 42 and 44 are each lithium manganese dioxide coin cell batteries. However, one or more of the power sources may be any known battery type suitable for the size and power requirements of portable lighting device and light sources, respectively. Further, the power sources may be the same or different. In some examples, one or more of the power sources is not a battery, but instead is a fuel cell or a capacitor based energy storage device.

With reference to FIGS. 1 and 2, first power source 42 includes a positive terminal 48 (pictured in FIG. 1) and a negative terminal 46 surrounding the positive terminal in a can and cap configuration. Similarly, second power source 44 includes a positive terminal can 50 and a negative terminal cap 52.

In some examples, the lighting device includes a single power source. In other examples, the lighting device includes more than two power sources. Indeed, the number of power sources included in lighting device can be selected in view of a number of considerations, including providing sufficient power for the light sources, providing sufficient power to activate the light sources for a given amount of time, size of the lighting device, and cost of the lighting device. In some examples, two or more of the power sources are electrically connected in series, either fixedly or selectively, to increase the voltage, such to cause the light sources to illuminate more brightly. Parallel connections are also contemplated.

With reference to FIG. 2 it can be seen that lighting device 30 includes biasing mechanism 60 disposed between first power supply 42 and light housing 32. Biasing mechanism 60 biases first power source 42 toward second power source 44 and into an activated position. In other examples the biasing mechanism is positioned adjacent the second power source and biases the second power source toward the first power source. In still other examples the lighting device includes a second biasing mechanism that acts on the second power source to bias it towards the first power source as the first power source is biased toward the second power source. In further examples, one or more bias mechanisms bias the power sources apart rather than together.

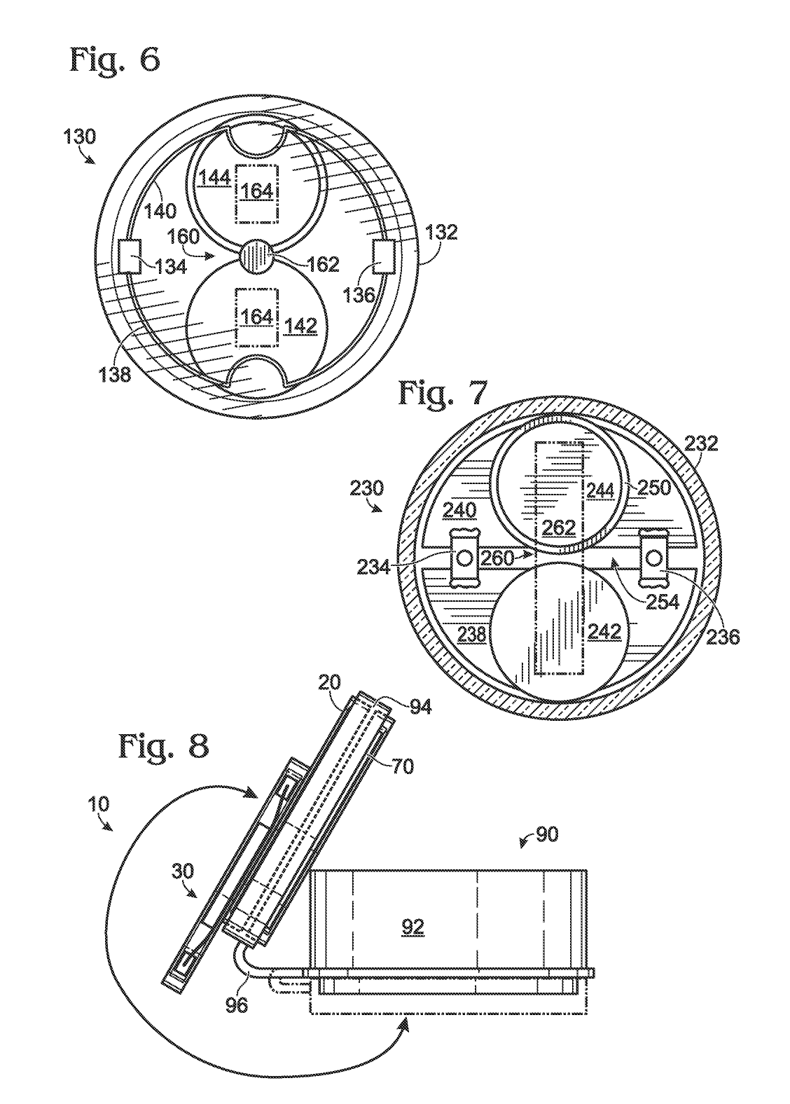

In the example shown in FIG. 2, biasing mechanism 60 includes a resilient member 62. In the present example, resilient member 62 is rubber, but springs and the like may also be used. In general, the biasing mechanism may be any conventional biasing member, mechanism, or device. For example, in FIG. 6 a biasing mechanism 160 is shown that includes an auxiliary magnet 162. In FIG. 7, a biasing mechanism 260 is shown that includes a friction surface 262.

In the examples shown in FIGS. 1-5, electrical contacts 38 and 40 electrically connect light sources 34 and 36 with power sources 42 and 44, respectively. In particular, electrical contact 38 is electrically connected to negative leads of first and second light source 34 and 36 and to a negative terminal of first power source 42. Electrical contact 40 is electrically connected to positive leads of first and second light sources 34 and 36 and to a positive terminal of second power source 44.

The electrical connections between the electrical contacts, power sources, and light sources just described represent an electrical circuit. However, the electrical circuit is either open (deactivated) or closed (activated) depending on the contact or lack thereof of power sources 42 and 44.

Specifically, the electrical circuit is activated when a negative terminal 46 of first power source 42 is in contact with a negative terminal 50 of second power source 44 in an activated position shown in FIG. 2. When, first and second power sources 42 and 44 are spaced from each other in a deactivated position, the electrical circuit is open or deactivated. Thus, the relative position of first and second power sources 42 and 44 represents a switch, in particular an Ellis Switch invented by the present applicant and inventor.

The position of lighting device 30 relative to primary magnet 20 in conjunction with biasing mechanism 60 serves to move first power source 42 between the deactivated position and the activated position. In the example shown in FIGS. 1-5, lighting device 30 is proximate to primary magnet 20 in the deactivated position and distal or offset from primary magnet 20 in the activated position. In the deactivated position, the magnetic attraction of first power source 42 towards the periphery of primary magnet 20 is sufficient to overcome the bias towards second power source 44 due to biasing mechanism 60. Thus, in the deactivated position the power sources are spaced from one another and the electrical circuit is open.

In the activated position, the magnetic attraction, if any, of first power source 42 towards periphery 24 of primary magnet 20 is insufficient to overcome the bias towards second power source 44 due to biasing mechanism 60. Thus, in the activated position the negative terminals 46 and 50 of first and second power sources 42 and 44, respectively, are in contact with each other and the electrical circuit is closed. Bias mechanism 60 serves to hold first power source 42 in the activated position, and thus maintain light sources 34 and 36 illuminating, when lighting device 30 is distal, offset, or entirely spaced from primary magnet 20.

In some examples, the power sources are oriented such that the positive terminals are in contact in the activated position. In other examples where the portable lighting device includes a single power source, the positive or negative terminal of the power source (as appropriate for the necessary flow of electrical charge in a given circuit arrangement) is in contact with the second electrical contact in the activated position and spaced from the second electrical contact in the deactivated position.

The inventor has observed that sliding lighting device 30 relative to primary magnet 20 between the proximate and distal positions will switch lighting device between the deactivated and activated positions, respectfully. The inventor has further observed the surprising and unpredicted result that separating lighting device 30 from primary magnet 20 in a direction normal to a first major face of primary magnet 20 will not switch lighting device to the activated position. Thus, the inventor has discovered a means to separate lighting device 30 from primary magnet 20 without switching lighting deice 30 to the activated position.

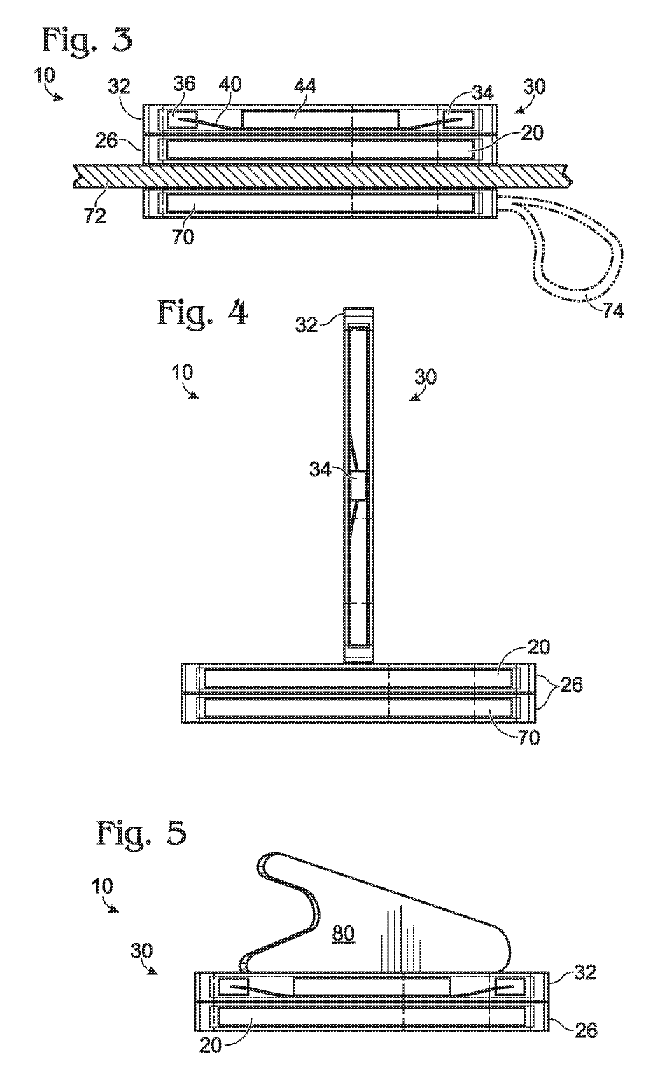

With reference to FIG. 3, it can be seen that in some examples, portable lighting system 10 includes a clamp magnet 70 for securing portable lighting device 30 and/or primary magnet 20 in a fixed position. In the example shown in FIG. 3, clamp magnet 70 is a neodymium magnet and produces a magnetic field sufficient to secure portable lighting device 30 and/or primary magnet 20 in a fixed position by magnetic attraction through an object 72 of considerable thickness. Stated another way, clamp magnet 70 can secure portable lighting device 30 and primary magnet 20 in a fixed position on object 72 when placed on an opposite side of object 72 from lighting device 30 and primary magnet 20.

The strength of the magnetic fields and of the components' attraction to the magnetic fields will determine how thick the object can be while maintaining the securing or clamping function of clamp magnet 70. When clamp magnet 70 is a neodymium magnets as shown in FIG. 3, it can secure portable lighting device 30 and primary magnet 20 through clothing, headbands, tents, doors, and windows.

As can be further seen in FIG. 3, clamp magnet 70 includes an optional loop 74 for securing items to portable lighting system 10. Given the strong clamping force developed by portable lighting system 10 when including clamp magnet 70, a variety of items, such as satchels, keys, or electronics can be supported off the ground by loop 74. Additionally or alternatively to loop 74, hooks, rings and the like may be provided for securing items. Additionally or alternatively, the primary magnet and/or the lighting device may include a loop, hook, ring or the like.

As can be seen in FIG. 4, lighting device 30 can be supported in an orientation transverse to primary magnet 20 by magnetic attraction between one or more of the components of lighting device 30 and primary magnet 20. In the example shown in FIG. 4, lighting device 30 is held in a perpendicular orientation relative to primary magnet 20. The transverse orientation shown in FIG. 4 can be useful for directing light from lighting device 30 to a target illumination area, such as toward a book, a trail, or a work area. Further, the transverse orientation shown in FIG. 4 can be useful for marking a trail in applications where one or more lighting systems 10 are placed along a trail as a guide.

FIG. 6 depicts a sundial capability of portable lighting system 10. In the example shown in FIG. 6, portable lighting system 10 includes a style 80 made of metal and held in a perpendicular orientation relative to lighting device 30 by interaction with the magnetic field of primary magnet 20. Portable lighting system 10 can serve as a sundial with appropriate time indicia marked on the top face of lighting device 30 and with proper orientation of portable lighting system 10 and style 80 relative to the sun. In some examples, the style is pivotally attached to the lighting device or to the primary magnet and selectively held in a stowed position parallel to the relevant primary face by a clasp for compact storage.

In some examples, the faces of the magnet housing and/or the light housing include indicia of a compass to serve as a compass. For example, a face of the magnet housing proximate the magnetic north pole of primary magnet may be marked with a symbol indicating that the face is facing geographic north. When hung from a string, such as through a loop attached to the magnet housing, the magnetic north pole of primary magnet will naturally orient itself to face the geographic north pole due to magnetic attraction to the earth's magnetic south pole residing close to the geographic north pole.

Additionally or alternatively, one or more of the primary magnet and the lighting device may include an aperture passing through its major faces. In one particular example, a major face of the magnet housing includes a mirrored finish. The mirrored finish can serve as a signaling mirror and the aperture can provide a means for a user to target where the light is being reflected. Additionally or alternatively, a lens may be positioned within the aperture. The lens is selected to concentrate light for fire starting purposes and/or for magnification or focusing capabilities.

Revolving the lighting device in a circle from the end of string while it is illuminating can also be used as an effective signaling device. The radius of the illuminated circle created by revolving the illuminating lighting device will depend on the length of the string. The string may be secured to the lighting device through an aperture in the lighting device or through a loop attached to the lighting device.

In some examples, the lighting device includes apertures or slits in the light housing to define a whistle. The apertures or slits are configured to channel air through a narrow passage and then through a wider passage to compress and then expand the air, respectively. The whistle and the whistle sounds it produces can be used to signal or communicate with other people.

In some examples, the lighting device includes solar power features to enable the power sources to recharge or operate when exposed to the sun. For example, the lighting device may include solar cells configured to convert light from the sun into electricity and appropriate circuitry to distribute that electricity to one or more power sources of lighting device. Additionally or alternatively, the lighting device may include a power generating device configured to utilize heat generated by solar radiation into electricity. The solar power features may be integral with lighting device or may be removable.

With reference to FIG. 8. the reader can see that portable lighting system 10 may include a system housing. In the example shown in FIG. 8, system housing 90 includes a body 92 defining a hollow interior, a lid 94, and a hinge 96 moveably connecting body 92 and lid 94. In some examples, system housing is made from, impregnated with, or lined with a magnetic shielding material, such as Giron™ magnetic shielding film, Mu-metal™, MagStop™, or magnetic shielding foils.

As can be seen in FIG. 8, lid 94 can be moved into a variety of positions relative to body 92, such as an open position shown in FIG. 8 and a closed position where lid 94 secures to housing body 92. In this particular example, body 92 is sized to receive primary magnet 20, lighting device 30, and clamp magnet 70, but system housings with other sizes may be selected. When system housing 90 is in the closed position, primary magnet 20 and lighting device 30 can be easily transported and protected from the elements.

When system housing 90 is in the open position (or a variety of positions between the open position and the closed position), one or more of primary magnet 20, lighting device 30 and clamp magnet 70 can be positioned in a variety of illumination configurations. One possible illumination configuration is shown in FIG. 8.

In the FIG. 8 configuration, lighting device 30 and primary magnet 20 is secured to a first side of lid 94 by clamp magnet 70 disposed on a second side of lid 94 opposite the first side. In particular, lighting device 30 is secured in a distal position relative to primary magnet 20 whereby the power sources are in the activated position and the light sources are illuminating. Because of the position of lid 94, lighting device 30 is illuminating an area toward the left of the page in FIG. 8; thus, it can be seen how modifying the position of lid 94 can serve to illuminate different targeted areas.

Another illumination configuration involves lighting device being placed inside the interior of body 92 while in the activated position with lid 94 in an open position. In this configuration, body 92 serves as a shade when made from a diffuse material or a reflector when made from a reflective or opaque material. Additionally or alternatively, primary magnet 20 and/or clamp magnet 70 may be placed on the outside of body 92 in a position to secure lighting device 30 inside body 92 by magnetic attraction. A variety of other illumination configurations are contemplated.

Turning attention to FIG. 6, a second example of a portable lighting device 130 will now be described. Portable lighting device 130 includes many similar or identical features to portable lighting device 30. Thus, for the sake of brevity, each feature of portable lighting device 130 will not be redundantly explained. Rather, key distinctions between lighting device 130 and lighting device 30 will be described in detail and the reader should reference the discussion above for features substantially similar between the two lighting devices.

It should be noted that lighting device 130 can be combined with primary magnet 20 to form another example of a portable lighting system. Further, lighting device 130 can be used with clamp magnet 70, style 80, or system housing 90 as described above. Moreover, with appropriate modifications as described above with regard to lighting device 30, lighting device 130 can serve as a compass, a sight glass, or a whistle as well as include solar power features as described above.

As can be seen in FIG. 6, lighting device 130 includes a light housing 132, which encloses a first light source 134, a second light source 136, a first electrical contact 138, a second electrical contact 140, a first power source 142, a second power source 144, and a biasing mechanism 160. The arrangement and cooperation of the light sources, electrical contacts and power sources is substantially similar to that described above.

However biasing mechanism 160 differs from biasing mechanism 60 in ways that will now be discussed in detail. Indeed, unlike biasing mechanism 60, biasing mechanism 160 includes an auxiliary magnet 162 and friction surfaces 164.

Auxiliary magnet 162 is disposed between and beneath first and second power sources 142 and 144. Auxiliary magnet 162 provides a magnetic field that attracts first and second power sources 142 and 144 to bias them towards each other into an activated position where they are in contact. The magnetic field of auxiliary magnet 162 also enables lighting device 130 to secure directly to ferrous surfaces, such as a wide variety of metal surfaces.

The magnetic field produced by auxiliary magnet 162 is selected to be weaker than the magnetic field produced by a primary magnet when lighting device 130 is in a proximate position relative to the primary magnet. The stronger force of magnetic attraction to the primary magnet experienced by one or more of power sources 142 and 144 is sufficient to overcome the bias toward auxiliary magnet 162. Thus, when lighting device 130 is in a position proximate a primary magnet, one or more of power sources 142 and 144 move apart into a spaced arrangement defining a deactivated position.

Friction surfaces 164 restrict first and second power sources 142 and 144 from moving relative to one another. In some examples, friction surfaces are directional and restrict the power sources from moving in only one direction relative to one another. For example, the friction surfaces may include angled projections directed toward the auxiliary magnet. Such an orientation of the angled surfaces would serve to restrict the power sources from moving away from one another, but would not significantly restrict them from moving closer to each other. Directing the angled projects away from the auxiliary magnet would have the opposite effect.

Turning attention to FIG. 7, a third portable lighting device 230 will now be described. Portable lighting device 230 includes many similar or identical features to portable lighting devices 30 and 130. Thus, for the sake of brevity, each feature of portable lighting device 230 will not be redundantly explained. Rather, key distinctions between lighting device 230 and lighting devices 30 and 130 will be described in detail and the reader should reference the discussion above for features substantially similar between the lighting devices.

It should be noted that lighting device 230 can be combined with primary magnet 20 to form another example of a portable lighting system. Further, lighting device 230 can be used with clamp magnet 70, style 80, or system housing 90 as described above. Moreover, with appropriate modifications as described above with regard to lighting device 30, lighting device 230 can serve as a compass, a sight glass, or a whistle as well as include solar power features as described above.

As can be seen in FIG. 7, lighting device 230 includes a light housing 232, which encloses a first light source 234, a second light source 236, a first electrical contact 238, a second electrical contact 240, a first power source 242, a second power source 244, and a biasing mechanism 260. The arrangement and cooperation of the light sources, power sources, and biasing mechanism is substantially similar to that described above. Biasing mechanism 260 includes a single frictional surface 262 instead of two discreet frictional surfaces 162 as described above, but the general principles and effect remain the same.

Electrical contacts 238 and 240 differ from electrical contacts 38 and 40 in size and shape. Instead of being wires or other elongate members, electrical contacts 238 and 240 are relatively large and substantially planar electrically conductive members. In the example shown in FIG. 7, electrical contacts 238 and 240 are metal members in the shape of half circles to compliment the shape of light housing 232.

As can be seen in FIG. 7, there is a gap 254 between electrical contacts 238 and 240. This gap serves to prevent current from flowing directly between the contacts, which would result in a short circuit of the electrical circuit selectively established by the combination of light sources, power supplies, and electrical contacts. In some examples, the gap is at least partially filled with an electrical insulator.

First power source 242 is mounted on electrical contact 238 in an orientation where its positive terminal is in electrical communication with electrical contact 238. Second power source 244 is mounted on electrical contact 240 in an orientation where its negative terminal 250 is in electrical communication with electrical contact 240. When the outer cap negative terminals of first and second power sources touch one another, an electrical circuit is created.

In examples where the lighting device includes a single power source, an electrical circuit is created when the positive terminal of the power source is in contact with the first electrical contact and the negative terminal of the power source is in contact with the second electrical contact.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A portable lighting system, comprising:
a primary magnet producing a magnetic field; and
a portable lighting device, comprising:
a housing;
a light source mounted within the housing and electrically connected to a first electrical contact and to a second electrical contact;
a power source that is magnetically attractable and that has a first terminal and a second terminal, the power source being disposed within the housing with the first terminal in contact with the first electrical contact and being configured to selectively move between a deactivated position where the second terminal is spaced from the second electrical contact and an activated position where the second terminal is touching the second electrical contact to energize the light source by selectively positioning the housing relative to the primary magnet.

2. The portable lighting system of claim 1, wherein the power source is held in the deactivated position by magnetic attraction toward the primary magnet when the housing is proximate the primary magnet.

3. The portable lighting system of claim 2, wherein the power source is held in the deactivated position by magnetic attraction toward a periphery of the primary magnet when the housing is proximate the primary magnet.

4. The portable lighting system of claim 2, wherein the housing and the primary magnet are each substantially disk shaped and the housing is supported in an orientation transverse to the primary magnet by magnetic attraction between the primary magnet and one or more of the power source, the first electric contact, and the second electric contact.

5. The portable lighting system of claim 4, wherein the housing is supported in an orientation perpendicular to the primary magnet with the power source in the activated position.

6. The portable lighting system of claim 1, further comprising a biasing mechanism biasing the power source toward the activated position.

7. The portable lighting system of claim 6, wherein the biasing mechanism includes an auxiliary magnet mounted between the power source and the electrical contact.

8. The portable lighting system of claim 7, wherein the auxiliary magnet produces a weaker magnetic field than the primary magnet.

9. The portable lighting system of claim 6, wherein the biasing mechanism includes a resilient member.

10. The portable lighting system of claim 1, further comprising a frictional surface engaging the power source in the activated position to inhibit the power source from moving away from the activated position.

11. The portable lighting system of claim 1, further comprising a clamp magnet producing a magnetic field sufficient to support at least the primary magnet and the portable lighting device through an object by magnetic attraction.

12. The portable lighting system of claim 1, wherein one or more of the primary magnet and the portable lighting device includes one or more of a loop, a hook, and a ring for supporting items.

13. The portable lighting system of claim 1, wherein one or more of the first electrical contact and the second electrical contact is a planar member.

14. The portable lighting system of claim 1, wherein the housing is made from rubber or includes a rubber coating.

15. The portable lighting system of claim 1, wherein the second electrical contact includes a second power source.

16. The portable lighting system of claim 15, wherein the second power source is magnetically attractable and biased toward the first power source, the second power source moving away from the first power source by magnetic attraction to the primary magnet when the housing is proximate the primary magnet.

17. The portable lighting system of claim 1, further comprising a style that is magnetically attractable and that is held in a position perpendicular to at least one of the primary magnet and the housing to form a sundial when the housing overlies the primary magnet by magnetic attraction to the primary magnet.

18. A portable lighting device, comprising:
a first power source that is magnetically attractable and that has a first terminal with a first electrical polarity and a second terminal with a second electrical polarity;
a second power source having a third terminal with the first electrical polarity and a fourth terminal with the second electrical polarity;
a light source electrically connected to the first terminal and to the fourth terminal; and
a biasing mechanism biasing the first power source toward an activated position where the second terminal is in contact with the fourth terminal to define an electrical circuit;
wherein in the presence of a magnetic field the first power source moves into a deactivated position where the second terminal is spaced from the fourth terminal to open the electrical circuit.

19. A portable lighting device, comprising:
a first battery including:
a can having a first electrical polarity; and
a cap surrounding a portion of the can and having a second electrical polarity;
a light source electrically connected to the can and to an electrical contact; and
a biasing mechanism biasing the first battery toward an activated position where the cap is in contact with the electrical contact to define an electrical circuit;
wherein in the presence of a magnetic field the battery moves into a deactivated position where the cap is spaced from the electrical contact to open the electrical circuit.

20. The portable lighting device of claim 19, further comprising a second battery including a second can with the first electrical polarity and a second cap with the second electrical polarity, wherein the electrical contact includes the second cap of the second battery.
